(19) United States
(12) Patent Application Publication
(10) Pub. No.: US 2009/0195930 A1
(43) Pub. Date: Aug. 6, 2009

(54) MAGNETIC RECORDING SLIDER WITH FLEX SIDE PADS

(76) Inventor: Jeffrey S. Lille, Sunnyvale, CA (US)

Correspondence Address: ZILKA-KOTAB, PC- HIT, P.O. BOX 721120, SAN JOSE, CA, 95172-1120, US

(21) Appl. No.: 12/023,997

(22) Filed: Jan. 31, 2008

(51) Int. Cl. G11B 5/60

(52) U.S. Cl. 360/234.5

(57) ABSTRACT

A system according to one embodiment comprises a slider having an air bearing surface side and a flex side, the flex side being positioned on an opposite side of the slider as the air bearing surface side; electrical pads on the flex side of the slider; and a heating device in electrical communication with the electrical pads, where the heating device comprises a least one optical element A method according to one embodiment comprises positioning pads of a heating device towards pads on a slider; detecting an impedance in a circuit including the pads of the heating device; moving the heating device relative to the slider to minimize the impedance; and coupling the heating device to the slider. Additional systems and methods are provided.

### FIELD OF THE INVENTION

The present invention relates to magnetic data storage systems, and more particularly, this invention relates to sliders of data storage systems and devices coupled to sliders.

### BACKGROUND OF THE INVENTION

The heart of a computer is a magnetic disk drive which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

### SUMMARY OF THE INVENTION

A system according to one embodiment comprises a slider having an air bearing surface side and a flex side, die flex side being positioned on an opposite side of the slider as the air bearing surface side; electrical pads on the flex side of the slider; and a heating device in electrical communication with the electrical pads, where the heating device comprises a least one optical element.

A system according to another embodiment comprises a slider having an air bearing surface side and a flex side, the flex side being positioned on an opposite side of the slider as the air bearing surface side; electrical pads on the flex side of the slider; a laser coupled to the flex side of the slider, the laser in electrical communication with the electrical pads; contact pads on a side of the slider extending between the air bearing surface side and the flex side, each of the electrical pads being electrically coupled to a respective one of the contact pads; and a waveguide passing through the slider for directing light from the flex side to the air bearing surface side, wherein an optical output of the laser and the waveguide are aligned.

A system according to yet another embodiment comprises a slider having an air bearing surface side and a flex side, the flex side being positioned on an opposite side of the slider as the air bearing surface side; position pads on the flex side of the slider; and a heating device coupled to the flex side of the slider, the heating device having pads aligned with the position pads.

A method according to one embodiment comprises positioning pads of a heating device towards pads on a slider; detecting an impedance in a circuit including the pads of the heating device; moving the heating device relative to the slider to minimize the impedance; and coupling the heating device to the slider.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system.

FIG. 2A is a schematic representation in section of a recording medium utilizing a longitudinal recording format.

FIG. 2B is a schematic representation of a conventional magnetic recording head and recording medium combination for longitudinal recording as in FIG. 2A.

FIG. 2C is a magnetic recording medium utilizing a perpendicular recording format.

FIG. 2D is a schematic representation of a recording head and recording medium combination for perpendicular recording on one side.

FIG. 2E is a schematic representation of the recording apparatus of the present invention, similar to that of FIG. 2D, but adapted for recording separately on both sides of the medium.

FIG. 3 is a graphical depiction of bit lengths.

FIG. 4 is a graph of Coercivity versus Temperature of a material in a recording layer of a magnetic medium.

FIG. 5 is a system diagram of a system for localized heating of the magnetic medium for thermally assisted recording.

FIG. 6 is a perspective view of a system according to one embodiment.

FIG. 7 is a perspective view of an unassembled system according to one embodiment.

FIG. 8 is a partial side view of a system according to one embodiment.

FIG. 9 is a perspective view of an unassembled system according to one embodiment.

FIG. 10 is a perspective view of an unassembled system according to one embodiment.

FIGS. 10A-B are representative drawings showing misaligned and aligned pads, respectively.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

The following description discloses several preferred embodiments of magnetic storage systems, as well as operation and/or component parts thereof and/or systems and methods associated or integrated with magnetic storage systems.

In one general embodiment, a system comprises a slider having an air bearing surface side and a flex side, the flex side being positioned on an opposite side of the slider as the air bearing surface side; electrical pads on the flex side of the slider; and a heating device in electrical communication with the electrical pads, where the heating device comprises a least one optical element.

In another general embodiment, a system comprises a slider having an air bearing surface side and a flex side, the flex side being positioned on an opposite side of the slider as the air bearing surface side; electrical pads on the flex side of the slider; a laser coupled to the flex side of the slider, the laser in electrical communication with the electrical pads; contact pads on a side of the slider extending between the air bearing surface side and the flex side, each of the electrical pads being electrically coupled to a respective one of the contact pads; and a waveguide passing through the slider for directing light from the flex side to the air bearing surface side, wherein an optical output of the laser and the waveguide are aligned.

In yet another general embodiment, a system comprises a slider having an air bearing surface side and a flex side, the flex side being positioned on an opposite side of the slider as the air bearing surface side; position pads on the flex side of the slider; and a heating device coupled to the flex side of the slider, the heating device having pads aligned with the position pads.

In one general embodiment, a method comprises positioning pads of a heating device towards pads on a slider; detecting an impedance in a circuit including the pads of the heating device; moving the heating device relative to the slider to minimize the impedance; and coupling the heating device to the slider.

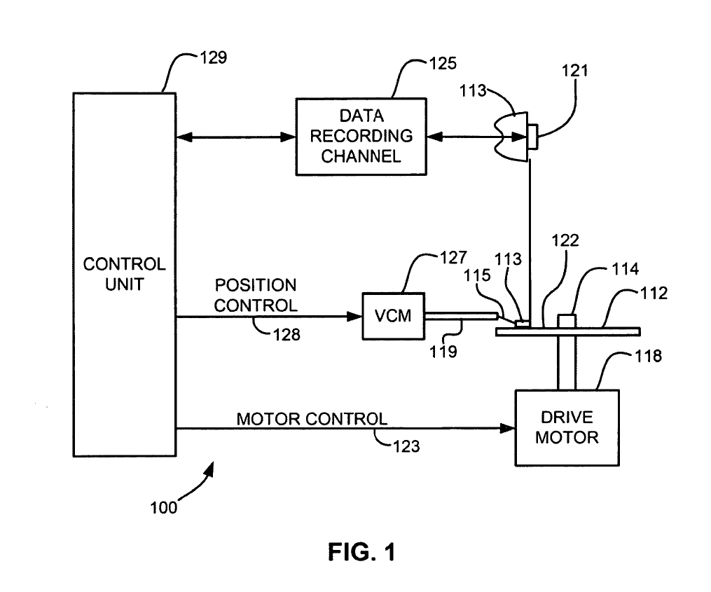

Referring now to FIG. 1, there is shown a disk drive 100 in accordance with one embodiment of the present invention. As shown in FIG. 1, at least one rotatable magnetic disk 112 is supported on a spindle 114 and rotated by a disk drive motor 118. The magnetic recording on each disk is in the form of an annular pattern of concentric data tracks (not shown) on the disk 112.

At least one slider 113 is positioned near the disk 112, each slider 113 supporting one or more magnetic read/write heads 121. As the disks rotate, slider 113 is moved radially in and out over disk surface 122 so that heads 121 may access different tracks of the disk where desired data are recorded. Each slider 113 is attached to an actuator arm 119 by means of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write heads 121 by way of recording channel 125.

The above description of a typical magnetic disk storage system, and the accompanying illustration of FIG. 1 are for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write head includes a coil layer embedded in one or more insulation layers (insulation stack), the insulation stack being located between first and second pole piece layers. A gap is formed between the first and second pole piece layers by a gap layer at an air bearing surface (ABS) of the write head. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium. Since magnetic flux decays as it travels down the length of the narrow second pole tip, shortening the second pole tip will increase the flux reaching the recording media. Therefore, performance can be optimized by aggressively placing the flare point close to the ABS.

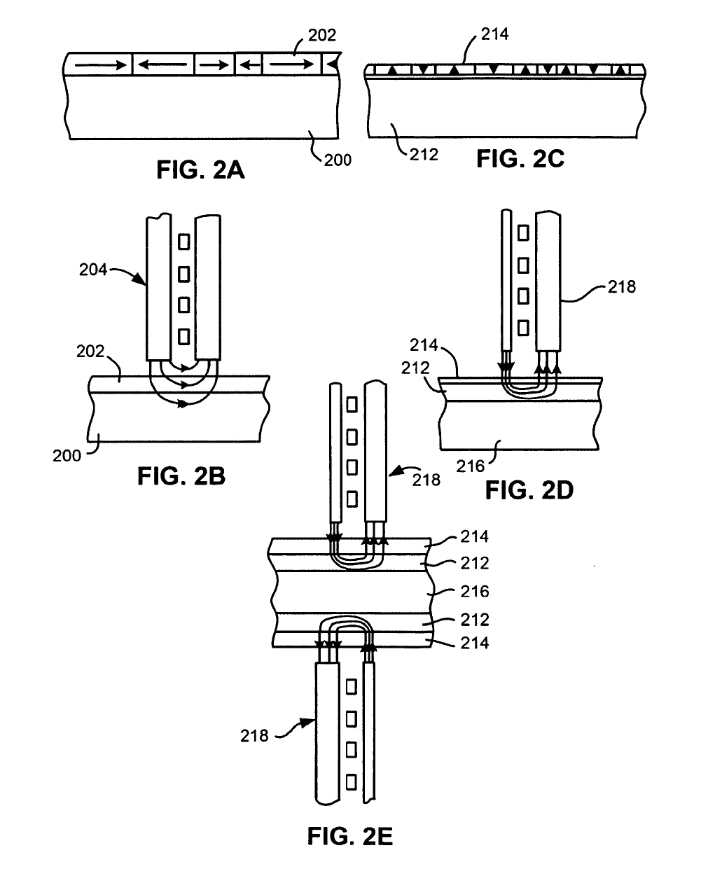

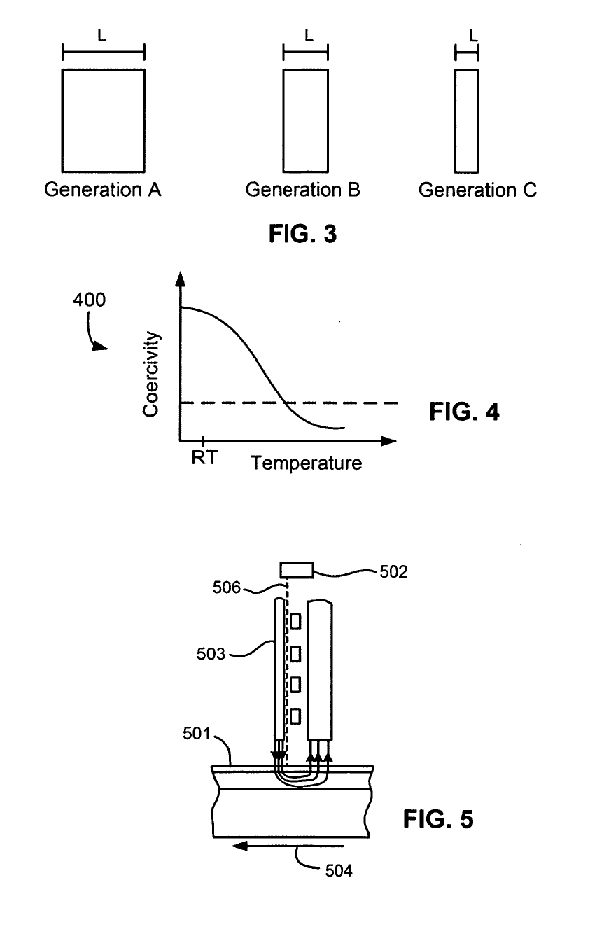

FIG. 2A illustrates, schematically, a conventional recording medium such as used with conventional magnetic disc recording systems, such as that shown in FIG. 3A. This medium is utilized for recording magnetic impulses in or parallel to the plane of the medium itself. The recording medium, a recording disc in this instance, comprises basically a supporting substrate 200 of a suitable non-magnetic material such as glass, with an overlying coating 202 of a suitable and conventional magnetic layer.

FIG. 2B shows the operative relationship between a conventional recording/playback head 204, which may preferably be a thin film head, and a conventional recording medium, such as that of FIG. 2A.

FIG. 2C illustrates schematically the orientation of magnetic impulses substantially perpendicular to the surface of the recording medium. For such perpendicular recording the medium includes an under layer 212 of a material having a high magnetic permeability. This under layer 212 is then provided with an overlying coating 214 of magnetic material preferably having a high anisotropy relative to the under layer 212.

Two embodiments of storage systems with perpendicular heads 218 are illustrated in FIGS. 2C and 2D (not drawn to scale). The recording medium illustrated in FIG. 2D includes both the high permeability under layer 212 and the overlying coating 214 of magnetic material described with respect to FIG. 2C above. However, both of these layers 212 and 214 are shown applied to a suitable substrate 216. Typically there is also an additional layer (not shown) called an “exchange-break” layer or “interlayer” between layers 212 and 214.

By this structure the magnetic lines of flux extending between the poles of the recording head loop into and out of the outer surface of the recording medium coating with the high permeability under layer of the recording medium causing the lines of flux to pass through the coating in a direction generally perpendicular to the surface of the medium to record information in the magnetically hard coating of the medium in the form of magnetic impulses having their axes of magnetization substantially perpendicular to the surface of the medium. The flux is channeled by the soft underlying coating 212 back to the return layer (P1) of the head 218.

FIG. 2E illustrates a similar structure in which the substrate 216 carries the layers 212 and 214 on each of its two opposed sides, with suitable recording heads 218 positioned adjacent the outer surface of the magnetic coating 214 on each side of the medium.

A continuing goal of magnetic recording is to maximize the number of bits stored per unit area of a magnetic medium. One way to do this is to increase the number of bits per track on the medium, such as by reducing the bit length along the data track. Referring to FIG. 3, there is shown a progression of bit length (L) reduction on the magnetic medium, referred to generically as Generation A, Generation B, and Generation C. However, reducing the bit length can lead to a loss of data from the disk due to such things as thermal fluctuations. Particularly, as the bit size is reduced, the energy that is required to flip the bit's magnetic polarity is reduced as a function of volume over temperature, as noted in Equation 1:

E˜KᵤV/kT Equation 1

where E is the Energy or heat required to flip the bit's polarity, V is the volume of magnetic medium that the bit occupies, Kᵤ is the anisotropy of the magnetic bit, k is the Boltzmann constant and T is the temperature. As the volume is reduced, the energy required to flip the bit is reduced and thermal fluctuations can lead to data loss. Since a reduction in volume of the bit is desired, but data loss is not acceptable, the anisotropy of the bit material must be higher at working temperatures to prevent the bit from flipping due to, e.g., thermal fluctuations, which could result in data loss. Therefore, selection of magnetic media with a higher anisotropy is desirable.

Writing to magnetic media having very high anisotropy becomes difficult, as increased anisotropy of a magnetic medium makes the disk more resistive to writing (changing the orientation of the bits). To overcome this increased resistivity to writing, the magnetic medium may be heated to reduce the amount of magnetic flux required to reorient the magnetic bits. FIG. 4 discloses a graph 400 (representative only) of Anisotropy (measured in Oersted) versus Temperature (measured in Kelvin). As shown, at room temperature (RT), the anisotropy of the magnetic medium is above a practically writeable anisotropy level, shown as dashed line 405 under which writing to the disk is feasible, preferably with conventional writing techniques, and above which the magnetic medium is stable and thermal fluctuations will not readily cause the bits to flip. The magnetic medium may be heated to reduce the anisotropy below the threshold 405, allowing writing to the magnetic medium. Therefore, by heating the magnetic medium, the magnetic medium will enter a state at which bits can be more easily oriented, thereby resulting in data being stored on the magnetic medium.

FIG. 5 illustrates a system for localized heating of the magnetic medium 501 for thermally assisted writing. The magnetic medium 501 moves in the direction of the arrow 504. A heating device 502 heats the magnetic medium just prior to the heated portion arriving at the writing pole 503 of the head, e.g., using a laser beam 506. This results in the magnetic medium having a reduced anisotropy due to the increased temperature of the medium adjacent the writing pole 503 of the head. After the heated portion of the magnetic medium 501 has moved past the writing pole 503 of the head, the temperature of the magnetic medium 501 decreases rapidly so that the anisotropy thereof returns to a higher, more stable level.

Illustrative heating devices may use a beam of light, a beam of electrons, radiation, etc. For instance, a laser may be used. In another approach, an electron emitter may employ an electron cone to focus electrons emitted therefrom onto the medium.

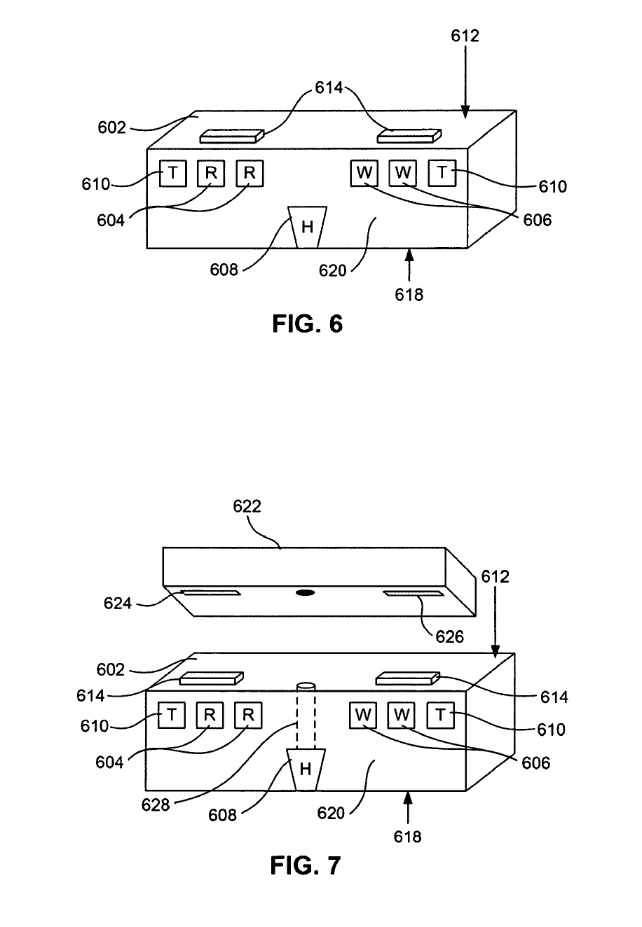

FIG. 6 shows a system comprising a slider 602 used in magnetic medium reading and recording operations. The slider 602 is shown with a head 608, and contact pads 604, 606, and 610. On the flex side 612 of the slider 602 opposite the air bearing surface side 618 of the slider 602, there are electrical pads 614. In this example, the electrical pads 614 are near the deposited end 620 of the slider 602. Illustrative purposes for electrical pads 614 include aligning a device with the flex side 612 of the slider 602, powering a device on the flex side 612 of the slider 602, or connecting any of the contact pads 604, 606, or 610 with or without a cable for coupling to a device on the flex side 612 of the slider 602.

In the embodiment shown in FIG. 6, the contact pads 604, 606, or 610 are on the deposited end 620 of the slider 602. Furthermore, one or more of the contact pads 604, 606, or 610 can be electrically coupled to a heater embedded in the slider 602 including in the head 608 of the slider 602. This heater can be used to induce thermal protrusion of the head 608 at the air bearing surface side 618 of the slider 602. Also, any of the contact pads 604, 606, or 610 can be writing pads or reading pads, and can be electronically coupled with or without a coupling cable to either of the electrical pads 614.

Further embodiments of the system in FIG. 6 include any of the contact pads 604, 606, or 610 electrically coupled with a reader of the slider 602 such as in the head 608 of the slider 602.

FIG. 7 includes all of the elements of FIG. 6 in addition to a beating device 622, positive electric pad 624, negative electric pad 626, wave guide 628, and heating signal. The heating device 622 can be a laser, electron emitter, etc. The wave guide 628 is used to pass light or heat from the flex side 612 of the slider 602 to the air bearing surface side 618 of the slider 602, and can be an embedded optical fiber, a channel void of material, or a channel filled with light guide forming resin, etc. The heating device 622 should be aligned prior to coupling it to the flex side 612 of the slider 602 to ensure proper orientation with the waveguide 628. Once attached, the heating device 622 can be powered through the slider 602 by supplying a current through positive electric pad 624 and negative electric pad 626, where positive electric pad 624 is aligned with flex side pad 614 and negative electric pad 626 is aligned with flex side pad 616. Once the heating device 622 is attached to the flex side 612 of the slider 602 and powered, it can be used to heat the magnetic medium located below the air bearing surface side 618 of the slider by shooting a heating signal through the wave guide 628.

In a variant of the system shown in FIG. 7, the waveguide 628 passes along at least a portion of the surface of the slider 602 for directing the heating signal from the flex side 612 of the slider 602 to the air bearing surface side 618 of the slider 602. For instance, a channel filled with a light guide forming oxide or resin may extend along a side of the slider 602. In another approach, a fiber optic cable may extend along a side of the slider 602.

In particularly preferred embodiments, the electrical pads 614 protrude from the flex side 612 of the slider 602. An illustrative purpose for this protrusion is to assist in positioning the heating device 622 before it is attached to the slider, as will soon become apparent.

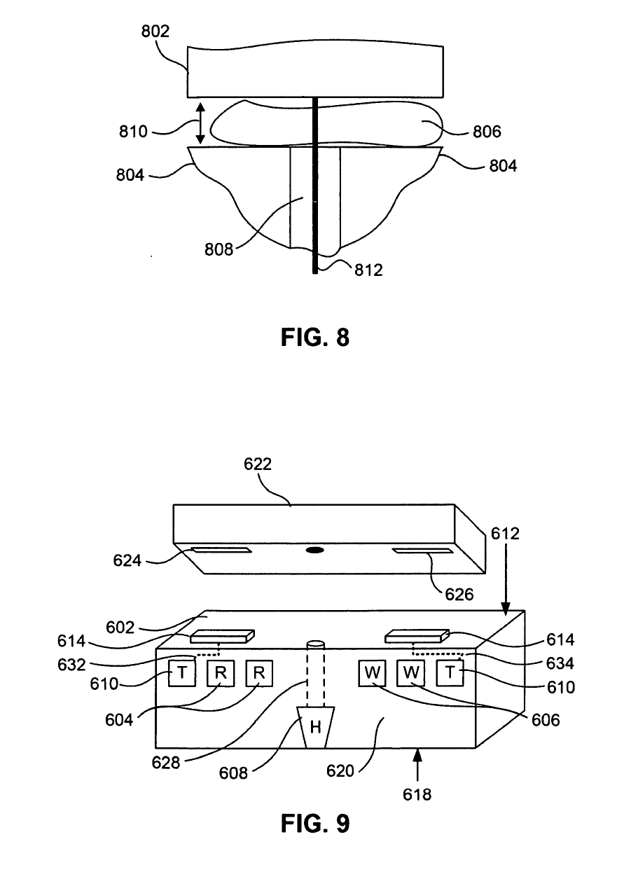

FIG. 8 shows a method of coupling the heating device 802 to the slider 804. FIG. 8 assumes that the heating device 802 and slider 804 have already been properly aligned. The interconnect material 806 is applied between the surfaces of the heating device 802 and slider 804 to couple the heating device 802 and slider 804. The distance 810 is preferably minimized between the heating device 802 and slider 804.

For illustrative purposes, the heating device 802 in FIG. 8 is a laser and the heating signal 812 is a laser beam. To reduce reflections of the laser beam 812, the interconnect material 806 should be an optically transmissive material with a refractive index equal to or less than that of the wave guide 808. For instance, the optically transmissive interconnect material may be a resin having a refractive index of less than about 2.2. An illustrative refractive index for the interconnect material 806 is approximately n˜1.62 when the wave guide 808 refractive index is n˜1.8-2.2. A preferable interconnect material 806 would be an epoxy type UV-curable adjustable refractive index optical adhesive from NTT Advanced Technology Corporation, Japan.

FIG. 9 contains common numbering with FIG. 7 as well as showing electrical connections 632 and 634 between the electrical pads 614 and contact pads 610 on the slider 602. In this arrangement, the heating device 622 and the flex side 612 of the slider 602 can be aligned by applying a current across contact pads 610. Then, the heating device 622 can be placed adjacent the flex side 612 of the slider 602 and slightly moved until the positive electric pad 624 aligns with one electrical pad 614, and negative electric pad 626 aligns with the other electrical pad. Though the pads are not in direct contact, a capacitive coupling occurs between the electric pads 624, 626 and the electrical pads 614. This creates a measurable capacitance that is indicative of a position that the heating device 622 is within a certain tolerance of being properly aligned with the wave guide 628. In addition to alignment, an electrical coupling, e.g., using solder, anisotropic conductive film, etc. may be used to directly couple the electric pads 624, 626 and the electrical pads 614 to power the heating device 622 during normal operation.

One approach for aligning, e.g., a heating device relative to the slider includes positioning pads of the heating device towards electrical pads on the slider. A capacitance is detected in a circuit including the pads of the heating device and the electrical pads. The heating device is then moved relative to the slider to maximize the capacitance. Upon achieving an acceptable alignment, the heating device is coupled to the slider. This method presumes that the various pads, when aligned, provide the proper alignment of the heating device relative to the slider, e.g., a laser outlet and a waveguide of the slider.

Equation 2 may be used for measuring capacitance between two surfaces.

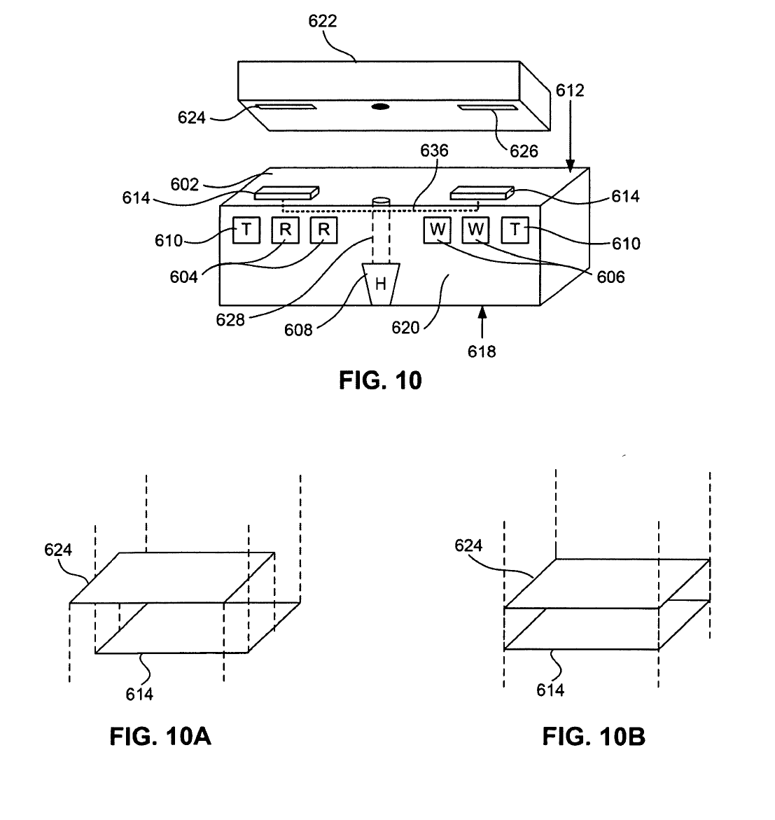

C˜∈ₒA_{A}/d Equation 2

where C is the capacitance, ∈ₒ is the dielectric constant between the surfaces, A_{A} is the area of alignment, or overlap, between the surfaces, and d is the distance between the surfaces. Therefore, capacitance will be maximized at a fixed distance, d, between the surfaces and when the area of overlap between the surfaces is maximized. See, e.g., FIGS. 10A and 10B, where FIG. 10B shows a preferred arrangement between pad 614 and pad 624.

FIG. 10 includes common numbering with FIG. 7, and includes an electrical connection 636 between that electrical pads 614, which can be used to align the electric pads of a device being attached to the flex side 612 of the slider 602 with the electrical pads 614. In this arrangement, alignment can be accomplished by creating a circuit through the heating device 622 which would flow through the positive electric pad 624 into one electrical pad 614, through electrical connection 636, out the other electrical pad 614, and into negative electric pad 626. The better aligned the two sets of pads are, i.e. one electrical pad 614 aligned with positive electric pad 624, and another electrical pad aligned with negative electric pad 626, the lower the impedance of the circuit, which is preferred. Any device capable of measuring the impedance may be used. In use, the impedance is detected during or after movements of the heating device relative to the slider. When the impedance is at a minimum, the device and slider are properly aligned. The device may then be coupled, preferably nonmovably coupled, to the slider. An electrical connection, e.g., via solder, anisotropic conductive film, etc. may be made between the adjacent pads, if necessary. Alternatively, the pads may merely be in physical contact.

FIG. 10A is illustrative of poor pad alignment. In FIG. 10A, electrical pad 614 is not properly aligned with positive electric pad 624. Because pad alignment cannot be perfect in every situation, slight variations in pad alignment may be accounted for. To ensure that each pad is aligned to a minimum deviation tolerance, a capacitance value as computed in Equation 2 (or other suitable equation) can be selected which acts as the threshold value associated with acceptable pad alignment. If the capacitance is at or above this threshold value, or at some maximum relative to a plurality of measurements, then the pads are aligned within acceptable tolerance. If the capacitance value is below the threshold value, then the pads are not aligned properly, and should be realigned before attaching the heating device 622 to the flex side of the slider 612.

It should be noted that methodology presented herein for at least some of the various embodiments may be implemented, in whole or in part, in hardware (e.g., logic), software, by hand, using specialty equipment, etc. and combinations thereof.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system, comprising:
a slider having an air bearing surface side and a flex side, the flex side being positioned on an opposite side of the slider as the air bearing surface side;
electrical pads on the flex side of the slider; and
a heating device in electrical communication with the electrical pads, where the heating device comprises a least one optical element.

2. A system as recited in claim 1, wherein the electrical pads protrude from the flex side.

3. A system as recited in claim 1, further comprising contact pads on a side of the slider extending between the air bearing surface side and the flex side, each of the electrical pads being electrically coupled to a respective one of the contact pads.

4. A system as recited in claim 3, further comprising a cable having a coupling portion, the coupling portion being coupled to the contact pads as well as reader pads and writer pads on the side of the slider extending between the air bearing surface side and the flex side.

5. A system as recited in claim 3, wherein the side is a deposited end of the slider.

6. A system as recited in claim 3, wherein at least one of the contact pads is also electrically coupled to a heater embedded in the slider.

7. A system as recited in claim 3, wherein at least one of the contact pads is also electrically coupled to a reader of the slider.

8. A system as recited in claim 1, wherein the heating device is a laser.

9. A system as recited in claim 1, wherein further comprising a waveguide passing through the slider for directing light from the flex side to the air bearing surface side, wherein an optical output of the heating device and the waveguide are aligned.

10. A system as recited in claim 1, wherein further comprising a waveguide passing along an outer surface of the slider for directing light from the flex side to the air bearing surface side, wherein an optical output of the heating device and the waveguide are aligned.

11. A system as recited in claim 1, further comprising an optically transmissive interconnect material between the slider and the heating device.

12. A system as recited in claim 11, wherein the optically transmissive interconnect material is a resin having a refractive index of less than about 2.2.

13. A system as recited in claim 11, further comprising a waveguide for directing light from the flex side to the air bearing surface side, wherein the optically transmissive interconnect material between the slider and the heating device has about a same refractive index as the waveguide.

14. A system, comprising:
a slider having an air bearing surface side and a flex side, the flex side being positioned on an opposite side of the slider as the air bearing surface side;
electrical pads on the flex side of the slider; and
a laser coupled to the flex side of the slider, the laser in electrical communication with the electrical pads;
contact pads on a side of the slider extending between the air bearing surface side and the flex side, each of the electrical pads being electrically coupled to a respective one of the contact pads;
a waveguide passing through the slider for directing light from the flex side to the air bearing surface side, wherein an optical output of the laser and the waveguide are aligned.

15. A system as recited in claim 14, further comprising a cable having a coupling portion, the coupling portion being coupled to the contact pads as well as reader pads and writer pads on the side of the slider extending between the air bearing surface side and the flex side.

16. A system as recited in claim 14, wherein the side is a deposited end of the slider.

17. A system as recited in claim 14, wherein at least one of the contact pads is also electrically coupled to a heater embedded in the slider.

18. A system as recited in claim 14, further comprising an optically transmissive interconnect material between the slider and the heating device.

19. A system as recited in claim 18, wherein the optically transmissive interconnect material is a resin having a refractive index of less than about 2.

20. A system as recited in claim 19, further comprising a waveguide for directing light from the flex side to the air bearing surface side, wherein the optically transmissive interconnect material between the slider and the heating device has about a same refractive index as the waveguide.

21. A system, comprising:
a slider having an air bearing surface side and a flex side, the flex side being positioned on an opposite side of the slider as the air bearing surface side;
position pads on the flex side of the slider; and
a heating device coupled to the flex side of the slider, the heating device having pads aligned with the position pads.

22. A system as recited in claim 21, wherein the position pads are not coupled to cable contact pads on the slider.

23. A system as recited in claim 21, wherein the position pads are electrically connected.

24. A method, comprising:
positioning pads of a heating device towards pads on a slider;
detecting an impedance in a circuit including the pads of the heating device;
moving the heating device relative to the slider to minimize the impedance; and
coupling the heating device to the slider.

25. A method as recited in claim 24, wherein the pads on the slider are electrical pads on a flex side of the slider, the flex side being positioned on an opposite side of the slider as an air bearing surface side of the slider.
